(19) United States
(12) Patent Application Publication
(10) Pub. No.: US 2025/0024469 A1
(43) Pub. Date: Jan. 16, 2025

(54) PHYSICAL SIDELINK FEEDBACK CHANNEL MAPPING

(71) Applicant: Samsung Electronics Co., Ltd., Suwon-si (KR)

(72) Inventor: Hongbo Si, Allen, TX (US)

(21) Appl. No.: 18/755,415

(22) Filed: Jun. 26, 2024

Related U.S. Application Data
(60) Provisional application No. 63/526,382, filed on Jul. 12, 2023.
(60) Provisional application No. 63/531,468, filed on Aug. 8, 2023.
(60) Provisional application No. 63/535,852, filed on Aug. 31, 2023.
(60) Provisional application No. 63/545,686, filed on Oct. 25, 2023.

(51) Int. Cl. H04W 72/25; H04L 5/00

(52) U.S. Cl. CPC H04W 72/25; H04L 5/0055

(57) ABSTRACT

A method of a user equipment (UE) in a wireless communication system is provided. The method includes receiving higher layer parameters; determining whether a first higher layer parameter is included in the higher layer parameters; determining, based on the first higher layer parameter, a physical sidelink feedback channel (PSFCH) transmission type when the first higher layer parameter is included; determining a resource block (RB) set for a transmission of a PSFCH; determining RBs in the RB set used for the transmission of the PSFCH based on the PSFCH transmission type; and transmitting the PSFCH according to the RBs in the RB set. All RBs in a first interlace are used for the transmission of the PSFCH when the PSFCH transmission type is a first type or RBs in a second interlace and RBs in a third interlace are used for the transmission of the PSFCH when a second type.

### CROSS-REFERENCE TO RELATED AND CLAIM OF PRIORITY

The present application claims priority under 35 U.S.C. § 119(e) to U.S. Provisional Patent Application No. 63/526,382 filed on Jul. 12, 2023; U.S. Provisional Patent Application No. 63/531,468 filed on Aug. 8, 2023; U.S. Provisional Patent Application No. 63/535,852 filed on Aug. 31, 2023; and U.S. Provisional Patent Application No. 63/545,686 filed on Oct. 25, 2023, which are hereby incorporated by reference in their entirety.

### TECHNICAL FIELD

The present disclosure relates generally to wireless communication systems and, more specifically, the present disclosure is related to apparatuses and method for physical sidelink feedback channel (PSFCH) mapping.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to PSFCH mapping.

In one embodiment, a user equipment (UE) in a wireless communication system is provided. The UE includes a transceiver configured to receive higher layer parameters and a processor operably coupled to the transceiver. The processor is configured to determine whether a first higher layer parameter is included in the higher layer parameters; determine, based on the first higher layer parameter from the higher layer parameters, a PSFCH transmission type when the first higher layer parameter is included in the higher layer parameters, determine a resource block (RB) set for a transmission of a PSFCH, and determine RBs in the RB set used for the transmission of the PSFCH based on the PSFCH transmission type. All RBs in a first interlace are used for the transmission of the PSFCH when the PSFCH transmission type is a first type or RBs in a second interlace and RBs in a third interlace are used for the transmission of the PSFCH when the PSFCH transmission type is a second type. The transceiver is further configured to transmit the PSFCH according to the RBs in the RB set.

In yet another embodiment, a method of a UE in a wireless communication system is provided. The method includes receiving higher layer parameters; determining whether a first higher layer parameter is included in the higher layer parameters; determining, based on the first higher layer parameter from the higher layer parameters, a PSFCH transmission type when the first higher layer parameter is included in the higher layer parameters; determining a RB set for a transmission of a PSFCH; determining RBs in the RB set used for the transmission of the PSFCH based on the PSFCH transmission type. All RBs in a first interlace are used for the transmission of the PSFCH when the PSFCH transmission type is a first type or RBs in a second interlace and RBs in a third interlace are used for the transmission of the PSFCH when the PSFCH transmission type is a second type. The method further includes transmitting the PSFCH according to the RBs in the RB set.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrates an example of a wireless transmit and receive paths according to embodiments of the present disclosure;

FIG. 5 illustrates a diagram of an example time domain resource determination for PSFCH according to embodiments of the present disclosure;

FIG. 6 illustrates a diagram of an example frequency domain resource mapping for PSFCH according to embodiments of the present disclosure; and

FIG. 7 illustrates a flowchart of an example UE procedure for PSFCH transmission/reception according to embodiments of the present disclosure.

### DETAILED DESCRIPTION

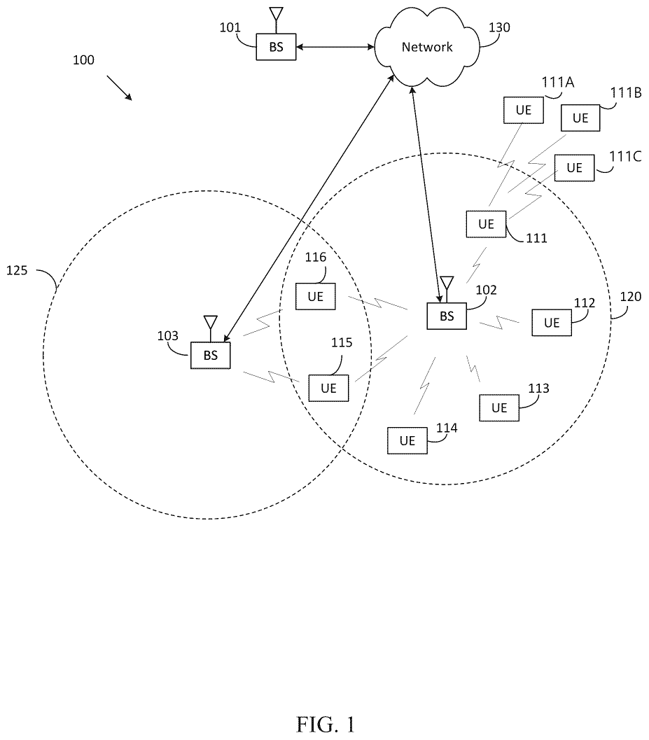

FIGS. 1-7, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v17.1.0, “NR; Physical channels and modulation;” [2] 3GPP TS 38.212 v17.1.0, “NR; Multiplexing and channel coding;” [3] 3GPP TS 38.213 v17.1.0, “NR; Physical layer procedures for control;” [4] 3GPP TS 38.214 v17.1.0, “NR; Physical layer procedures for data;” and [5] 3GPP TS 38.331 v17.1.0, “NR; Radio Resource Control (RRC) protocol specification;”

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing PSFCH mapping. In certain embodiments, one or more of the BSs 101-103 include circuitry, programing, or a combination thereof for supporting PSFCH mapping.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to common fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

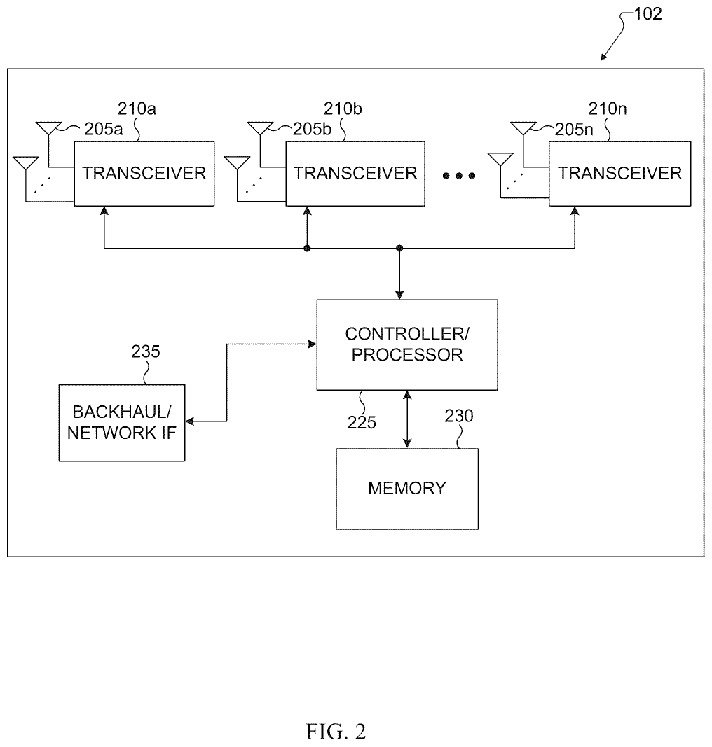

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting PSFCH mapping. Any of a wide variety of other functions could be supported in the gNB 102 by the controller/processor 225.

The controller/processor 225 is also capable of executing programs and other processes resident in the memory 230, such as PSFCH mapping. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

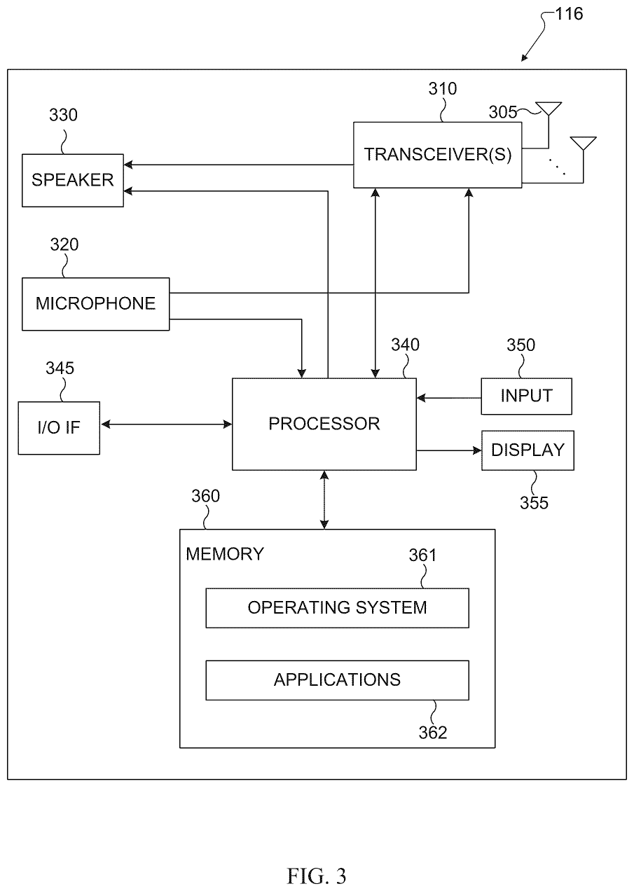

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for supporting or utilizing PSFCH mapping as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

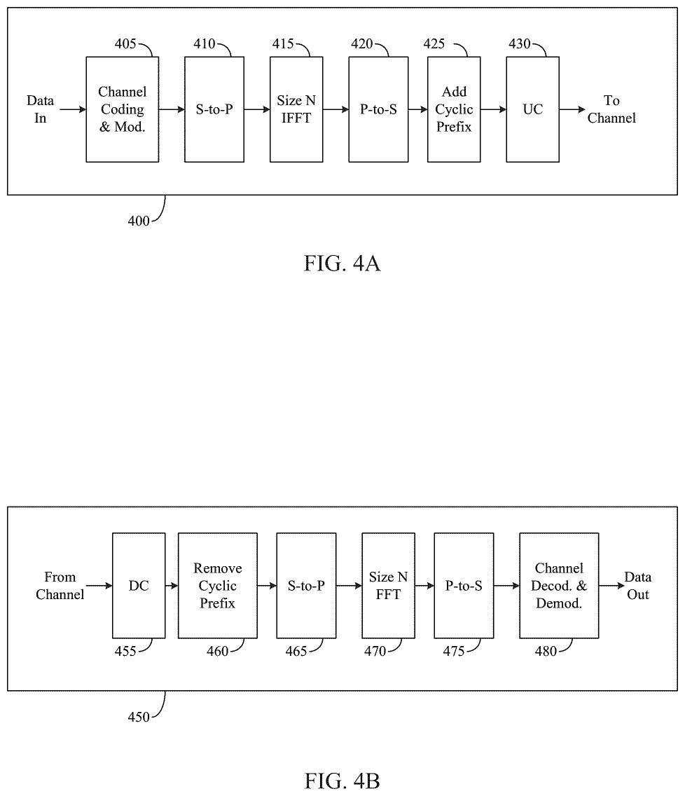

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. It may also be understood that the receive path 450 can be implemented in a first UE and that the transmit path 400 can be implemented in a second UE to support SL communications. In some embodiments, the transmit path 400 and/or receive path 450 is configured to support PSFCH mapping as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

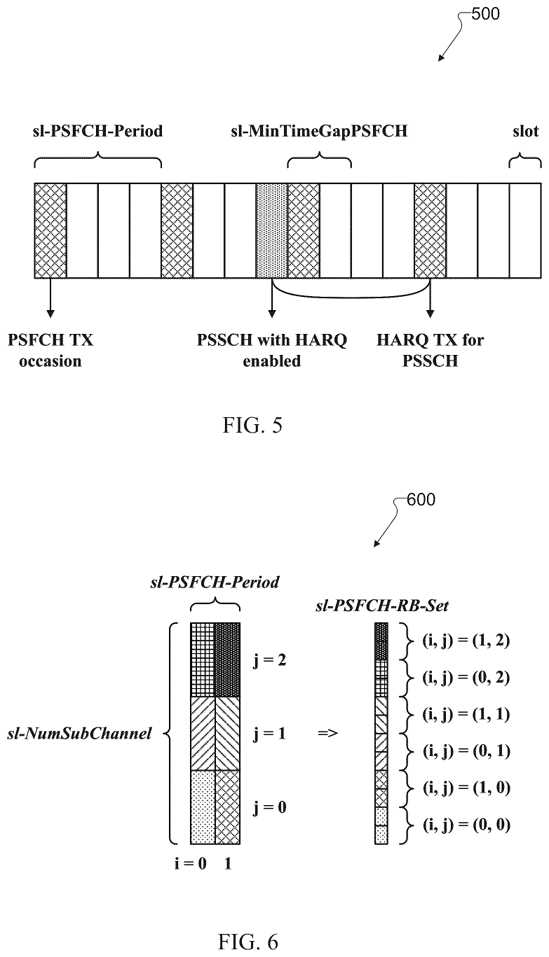

FIG. 5 illustrates a diagram of an example time domain resource determination 500 for PSFCH according to embodiments of the present disclosure. For example, time domain resource allocation 500 for PSFCH can be utilized by any of the UEs 111-111C, such as the UE 111A. This example is for illustration only and other embodiments can be used without departing from the scope of the present disclosure.

In time domain, the UE (e.g., the UE 111) can be provided with a number of slots (e.g., sl-PSFCH-Period) in the resource pool for a period of PSFCH transmission occasion resources. A slot in the resource pool is determined as containing a PSFCH transmission occasion if the relative slot index within the resource pool is an integer multiple of the period of PSFCH transmission occasion with at least a number of slots provided by sl-MinTimeGapPSFCH after the last slot of the physical sidelink shared channel (PSSCH) reception. PSFCH is transmitted in two contiguous symbols in a slot, wherein the second symbol is with index startSLsymbols+lengthSLsymbols−2 and the two symbols are repeated.

FIG. 6 illustrates a diagram of an example frequency domain resource mapping 600 for PSFCH according to embodiments of the present disclosure. For example, frequency domain resource allocation 600 for PSFCH can be utilized by any of the UEs 111-111C, such as the UE 111B. This example is for illustration only and other embodiments can be used without departing from the scope of the present disclosure.

In frequency domain, a PSFCH is transmitted in a single physical resource block (PRB), wherein the PRB is determined from a set of M_{PRB, set}^{PSFCH} based on an indication of a bitmap (e.g., sl-PSFCH-RB-Set). The UE determines a mapping from slot i (within N_{PSSCH}^{PSFCH} slots provided by sl-PSFCH-Period) and sub-channel j (within N_{subch} sub-channels provided by sl-NumSubchannel) to a subset of PRBs within the set of M_{PRB, set}^{PSFCH}, wherein the subset of PRBs are with index from (i+j·N_{PSSCH}^{PSFCH} )·M_{subch, slot}^{PSFCH} to (i+1+j·N_{PSSCH}^{PSFCH} )·M_{subch, slot}^{PSFCH}−1, with M_{subch, slot}^{PSFCH}=M_{PRB, set}^{PSFCH}/(N_{subch}·N_{PSSCH}^{PSFCH}). The UE determines a number of PSFCH resources available for multiplexing hybrid automatic repeat request acknowledgement (HARQ-ACK) information in a PSFCH transmission as R_{PRB, CS}^{PSFCH}=N_{type}^{PSFCH}·M_{subch, slot}^{PSFCH}·N_{CS}^{PSFCH}, wherein N_{type}^{PSFCH} is determined based on the type of resources that the PSFCH is associated with and N_{CS}^{PSFCH} is a number of cyclic shift pairs for the resource pool provided by sl-NumMuxCS-Pair. The UE determines an index of a PSFCH resource for a PSFCH transmission in response to a PSSCH reception as (P_{ID}+M_{ID}) mod R_{PRB, CS}^{PSFCH}, where P_{ID} is the source ID provided by the sidelink control information (SCI) scheduling the PSSCH and M_{ID} is the PSSCH receiver ID in groupcast SL transmission with acknowledgement (ACK) or negative acknowledgement (NACK) information in HARQ-feedback.

For sidelink operating on unlicensed or shared spectrum, embodiments of the present disclosure recognizes that there is a need to enhance the PSFCH in time domain and/or frequency domain and/or code domain, such that the transmitter and receiver of the PSFCH have no ambiguity in the resource for transmitting and/or receiving the PSFCH transmission. Also, due to channel access procedure on unlicensed or shared spectrum, there is an uncertainty for the transmission of PSFCH due to a failure of channel sensing and, hence, enhancement to compensate the transmission opportunity of PSFCH in time domain should be supported. The embodiments and/or examples in this disclosure can be used for sidelink operating on unlicensed or shared spectrum, but may not be limited to sidelink operating on unlicensed or shared spectrum.

This disclosure focuses on the enhanced PSFCH transmission for unlicensed operation in order to mitigate the impact from channel access failure. More precisely, the following aspects are included in the disclosure.
Resource allocation for a PSFCH
Sequence generation for the PSFCH
Mapping between PSSCH and PSFCH
Example UE procedure

In one embodiment, resource allocated for a PSFCH transmission can be based on at least one interlace index, wherein an interlace is a set of resource blocks (RBs) in the SL bandwidth part (BWP) and with uniform interval.

In a first type of PSFCH, the resource allocated for a PSFCH transmission can be based on a first interlace within a RB-set. For instance, RBs in the first interlace within a RB-set can be denoted as {m₁, m₁+M, m₁+2M, . . . , m₁+k₁M, . . . , m₁+(K₁−1)M}, wherein a RB can be denoted as s₁=m₁+k₁M, m₁ is the index of the starting RB within the first interlace within the RB-set, M is number of interlaces in the SL BWP (e.g., M=10 for 15 kHz subcarrier spacing (SCS), and/or M=5 for 30 kHz SCS), and K₁ is a number of RBs in the interlace and RB-set (e.g., K₁=10 or 11). For the first type of PSFCH, RBs in the first interlace are included in the resource for PSFCH transmission, e.g., k₁€{0, 1, . . . , K₁−1}. Further, m₁ can be determined based on the first common RB index in the SL BWP that includes the first interlace, and the index of the first interlace, and the index of the RB-set.

In one example, the first interlace in the first type of PSFCH can be provided to the UE (e.g., the UE 111) by indicating an index of the first interlace, e.g., using a (pre-) configuration.

In another example, a UE can determine an index of the first interlace based on a pre-defined association between resource for PSSCH and the index of the first interlace, e.g., as shown in examples of this disclosure.

In yet another example, a UE can determine RBs in the first interlace based on a pre-defined association between resource for PSSCH and the RBs in the first interlace.

In yet another example, a UE can determine an index of the first interlace based on an indication in SCI.

In one example, the UE can be provided with information on the RB-set by a (pre-) configuration.

In another example, the UE can determine the RB-set as the RB-set with lowest index within the RB-sets where the associated PSSCH is transmitted (e.g., this example can be applicable if sl-PSFCH-CandidateResourceType is indicated as startSubCH).

In yet another example, the UE can determine the RB-set as every RB-set (e.g., RB-sets) with within the RB-sets where the associated PSSCH is transmitted (e.g., this example can be applicable if sl-PSFCH-CandidateResourceType is indicated as allocSubCH).

In a second type of PSFCH, the resource allocated for a PSFCH transmission can be based on RB(s) in a second interlace and RB(s) in a third interlace, wherein the RBs are all within a RB-set. For one instance, RBs in the second interlace within a RB-set can be denoted as {m₂, m₂+M, m₂+2M, . . . , m₂+k₂M, . . . , m₂₊(K₂−1)M}, wherein a RB can be denoted as s₂=m₂+k₂M, m₂ is the index of the starting RB within the second interlace within the RB-set (e.g., m₂ can be determined based on the second interlace index and the RB-set index), M is number of interlaces in the SL BWP (e.g., M=10 for 15 kHz SCS, and M=5 for 30 kHz SCS) and K₂ is a number of RBs in the second interlace and RB-set (e.g., K₃=10 or 11). For another instance, RBs in the third interlace within a RB-set can be denoted as {m₃, m₃+M, m₃+2M, . . . , m₃+k₃M, . . . , m₃₊(K₃−1)M}, wherein a RB can be denoted as s₃=m₃+k₃M, m₃ is the index of the starting RB within the third interlace within the RB-set (e.g., m₃ can be determined based on the third interlace index and the RB-set index), M is number of interlaces in the SL BWP (e.g., M=10 for 15 kHz SCS, and M=5 for 30 kHz SCS), and K₃ is a number of RBs in the third interlace and RB-set (e.g., K₃=10 or 11). For the second type of PSFCH, each, or part, of the RBs are selected from the second and/or the third interlaces, e.g., k₂ is selected from {0, 1, . . . , K₂−1} (denoting the set of k₂ after selection as S₂) and k₃ is selected from {0, 1, . . . , K₃−1} (denoting the set of k₃ after selection as S₃). Further, m₂ can be determined based on the first common RB index in the SL BWP that includes the second interlace, and the index of the second interlace, and the index of the RB-set. Further, m₃ can be determined based on the first common RB index in the SL BWP that includes the third interlace, and the index of the second interlace, and the index of the RB-set.

In one example, the second interlace in the second type of PSFCH can be provided to the UE by indicating an index of the second interlace, e.g., using a (pre-)configuration.

In another example, the second interlace in the second type of PSFCH can be fixed, e.g., the interlace with index 0.

In yet another example, the second interlace in the second type of PSFCH can be determined based on the bitmap indicating the available resources for PSFCH (e.g., sl-PSFCH-RB-Set or sl-RB-SetPSFCH). For one instance, the second interlace is determined as the interlace which has all RBs available indicated by the bitmap and with the lowest interlace index. For another instance, the second interlace is determined as the interlace which has all RBs not available (e.g., the lowest interlace if multiple interlaces are not available).

In one example, the third interlace in the second type of PSFCH can be provided to the UE by indicating an index of the third interlace, e.g., using a (pre-)configuration. For one instance, the (pre-)configuration can be per SL BWP. For another instance, the (pre-)configuration can be per resource pool. For yet another instance the (pre-) configuration can be per RB-set.

In another example, the RB(s) in the third interlace in the second type of PSFCH can be provided to the UE (e.g., the UE 111) by a number of RB(s) (e.g., the number of RB(s) can be provided by a (pre-) configuration). The UE can determine the RB indexes and index of the third interlace based on the number of RB(s) according to a pre-defined association between resource for PSSCH and the resource for the PSFCH.
For one instance, when the number of RBs in the third interlace is 1, S₃={k′₃}, wherein k′₃ is determined based on a pre-defined association between resource for PSSCH and the resource for the PSFCH (e.g., according to example of this disclosure).
For another instance, when the number of RBs in the third interlace is 2, S₃={k′₃, k′₃+5}, wherein k′₃ is determined based on a pre-defined association between resource for PSSCH and the resource for the PSFCH (e.g., according to example of this disclosure).
For yet another instance, when the number of RBs in the third interlace is 2, S_{3={}k′₃, k′₃+1}, wherein k′₃ is determined based on a pre-defined association between resource for PSSCH and the resource for the PSFCH (e.g., according to example of this disclosure).
For yet another instance, when the number of RBs in the third interlace is 2, S₃ can be (pre-)configured between {k′₃, k′₃+1} and {k′₃, k′₃+5}, wherein k′₃ is determined based on a pre-defined association between resource for PSSCH and the resource for the PSFCH (e.g., according to example of this disclosure).
For yet another instance, when the number of RBs in the third interlace is 5, S₃={k′₃, k′₃+2, k′₃+4, k′₃+6, k′_{3+8},} wherein k′₃ is determined based on a pre-defined association between resource for PSSCH and the resource for the PSFCH (e.g., according to example of this disclosure).
For yet another instance, when the number of RBs in the third interlace is 5, S₃={k′₃, k′₃+1, k′₃+2, k′₃+3, k′₃+4}, wherein k′₃ is determined based on a pre-defined association between resource for PSSCH and the resource for the PSFCH (e.g., according to example of this disclosure).
For yet another instance, when the number of RBs in the third interlace is 2, S₃ can be (pre-)configured between {k′₃, k′₃+2, k′₃+4, k′₃+6, k′₃+8} and {k′₃, k′₃+1, k′₃+2, k′₃+3, k′₃+4}, wherein k3 is determined based on a pre-defined association between resource for PSSCH and the resource for the PSFCH (e.g., according to example of this disclosure).

In yet another example, the RB(s) in the third interlace in the second type of PSFCH can be provided to the UE by explicitly providing the indexes of the RB(s). For instance, the indication can be provided in the SCI.

In one example, the UE can be provided with information on the RB-set by a (pre-) configuration.

In another example, the UE can determine the RB-set as the RB-set with lowest index within the RB-sets where the associated PSSCH is transmitted (e.g., this example can be applicable if sl-PSFCH-CandidateResourceType is indicated as startSubCH).

In yet another example, the UE can determine the RB-set as every RB-set (e.g., all RB-sets) with within the RB-sets where the associated PSSCH is transmitted (e.g., this example can be applicable if sl-PSFCH-CandidateResourceType is indicated as allocSubCH).

In one example, the UE procedure for determining the resources for the second type of PSFCH can be as follows:
1. The UE determines an index of the RB-set.
2. The UE determines an index of the second interlace and then decide the set S₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.
4. The UE determines S₂ and S₃ as the RBs for PSFCH.

In another example, the UE procedure for determining the resources for the second type of PSFCH can be as follows:
1. The UE determines an index of the RB-set.
2. The UE determines an index of the second interlace and then decide a set S′₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.
4.

```
For k₂ = 0 to K₂ − 1
  If |m₂ + k₂M − s₃ + 1| ≤ 5 for any s₃ ∈ S₃, when the SCS of
  PSFCH is 15 kHz;
  and/or if |m₂ + k₂M − s3 + 1| ≤ 2 for any s₃ ∈ S₃, when the
  SCS of PSFCH is 30
  kHz;
    m₂ + k₂M is not included in set S₂;
  Otherwise
  m₂ + k₂M is included in set S₂;
  End
End
```

5. The UE determines S₂ and S₃ as the RBs for PSFCH.

In yet another example, the UE procedure for determining the resources for the second type of PSFCH can be as follows, wherein for instance c₁=5, and/or c₂=2; or for instance c₁=4, and/or c₂=1; or for instance c₁=6, and/or c₂=3:
1. The UE determines an index of the RB-set.
2. The UE determines an index of the second interlace and then decide a set S′₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.
4.

```
For k₂ = 0 to K₂ − 1
  If |m₂ + k₂M − s₃| ≤ c₁ for any s₃ ∈ S₃, when the SCS of PSFCH is
  15 kHz;
  and/or if |m₂ + k₂M − s₃| ≤ c₂ for any s₃ ∈ S₃, when the SCS of
  PSFCH is 30
  kHz;
    m₂ + k₂M is not included in set S₂;
  Otherwise
    m₂ + k₂M is included in set S₂;
  End
End
```

5. The UE determines S₂ and S₃ as the RBs for PSFCH.

In another example, the UE procedure for determining the resources for the second type of PSFCH can be as follows:
1. The UE determines an index of the RB-set.
2. The UE determines an index of the second interlace and then decide a set S′₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.
4.

```
For k₂ = 0 to K₂ − 1
  If |m₂ + k₂M − s₃ − 1| ≤ 5 for any s₃ ∈ S₃, when the SCS of
  PSFCH is 15 kHz;
  and/or if |m₂ + k₂M − s₃ − 1| ≤ 2 for any s₃ ∈ S₃, when the
  SCS of PSFCH is 30
  kHz;
    m₂ + k₂M is not included in set S₂;
  Otherwise
    m₂ + k₂M is included in set S₂;
  End
End
```

5. The UE determines S₂ and S₃ as the RBs for PSFCH.

In yet another example, the UE procedure for determining the resources for the second type of PSFCH can be as follows:
1. The UE determines an index of the RB-set.
2. The UE determines an index of the second interlace and then decide a set S′₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.
4.

```
For k₂ = 0 to K₂ − 1
  If |m₂ + k₂M − s₃ + 1| ≤ 5 for any s₃ ∈ S₃ and if k₂ ≠ 0 and if
  k₂ ≠ K₂ − 1,
  when the SCS of PSFCH is 15 kHz; and/or if |m₂ + k₂M − s₃ +
  1| ≤ 2 for any
  s₃ ∈ S₃ and if (k₂ = 0 or k₂ = K₂ − 1), when the SCS of PSFCH
  is 30 kHz;
    m₂ + k₂M is not included in set S₂;
  Otherwise
    m₂ + k₂M is included in set S₂;
  End
End
```

5. The UE determines S₂ and S₃ as the RBs for PSFCH.

In yet another example, the UE procedure for determining the resources for the second type of PSFCH can be as follows, wherein for instance c₁=5, and/or c₂=2; or for instance c₁=4, and/or c₂=1; or for instance c₁=6, and/or c₂=3:
1. The UE determines an index of the RB-set.
2. The UE determines an index of the second interlace and then decide a set S′₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.
4.

```
For k₂ = 0 to K₂ − 1
  If |m₂ + k₂M − s₃| ≤ c₁ for any s₃ ∈ S₃ and if k₂ ≠ 0 and if
  k₂ ≠ K₂ − 1, when
  the SCS of PSFCH is 15 kHz; and/or if |m₂ + k₂M − s₃| ≤ c₂ for
  any s₃ ∈ S₃ and
  if (k₂ = 0 or k₂ = K₂ − 1), when the SCS of PSFCH is 30 kHz;
    m₂ + k₂M is not included in set S₂;
  Otherwise
    m₂ + k₂M is included in set S₂;
  End
End
```

5. The UE determines S₂ and S₃ as the RBs for PSFCH.

In yet another example, the UE procedure for determining the resources for the second type of PSFCH can be as follows:
1. The UE determines an index of the RB-set.
2. The UE determines an index of the second interlace and then decide a set S′₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.
4.

```
For k₂ = 0 to K₂ − 1
  If |m₂ + k₂M − s₃ − 1| ≤ 5 for any s₃ ∈ S₃ and if k₂ ≠ 0 and if
  k₂ ≠ K₂ − 1,
  when the SCS of PSFCH is 15 kHz; and/or if |m₂ + k₂M − s₃ −
  1| ≤ 2 for any
  s₃ ∈ S₃ and if (k₂ = 0 or k₂ = K₂ − 1), when the SCS of PSFCH
  is 30 kHz;
    m₂ + k₂M is not included in set S₂;
  Otherwise
    m₂ + k₂M is included in set S₂;
  End
End
```

5. The UE determines S₂ and S₃ as the RBs for PSFCH.

In yet another example, the UE procedure for determining the resources for the second type of PSFCH can be as follows:
1. The UE determines an index of the RB-set.
2. The UE determines an index of the second interlace and then decide a set S′₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.
4.

```
For k₂ = 0 to K₂ − 1
  If |m₂ + k₂M − s₃ + 1| ≤ 5 for any s₃ ∈ S₃ and if |sₘₐₓ − sₘᵢₙ +
  1| ≥ 89 where
  sₘₐₓ and sₘᵢₙ are the largest and smallest in set S₃ ∪ S₂′ \ {m₂ +
  k₂M}, when the
  SCS of PSFCH is 15 kHz; and/or if |m₂ + k₂M − s₃ + 1| ≤ 2 for
  any s₃ ∈ S₃ and
  if |sₘₐₓ − sₘᵢₙ + 1| ≥ 45 where sₘₐₓ and sₘᵢₙ are the largest and
  smallest in set
  S₃ ∪ S₂′ \ {m₂ + k₂M}, when the SCS of PSFCH is 30 kHz;
    m₂ + k₂M is not included in set S₂, and m₂ + k₂M is removed
    from S₂′;
  Otherwise
    m₂ + k₂M is included in set S₂;
  End
End
```

5. The UE determines S₂ and S₃ as the RBs for PSFCH.

In yet another example, the UE procedure for determining the resources for the second type of PSFCH can be as follows, wherein for instance c₁=5, and/or c₂=2; or for instance c₁=4, and/or c₂=1; or for instance c₁=6, and/or c₂=3; or for instance, c₃=89, and/or c₄=45; or for instance, c₃=88, and/or c₄=44:
1. The UE determines an index of the RB-set.
2. The UE determines an index of the second interlace and then decide a set S′₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.
4.

```
For k₂ = 0 to K₂ − 1
  If |m₂ + k₂M − s₃| ≤ c₁ for any s₃ ∈ S₃ and if |sₘₐₓ − sₘᵢₙ + 1| ≥
  c₃ where
  sₘₐₓ and sₘᵢₙ are the largest and smallest in set S₃ ∪ S₂′ \ {m₂ + k₂M},
  when the
  SCS of PSFCH is 15 kHz, and/or if |m₂ + k₂M − s₃| ≤ c₂ for any s₃ ∈
  S₃ and if
  |sₘₐₓ − sₘᵢₙ + 1| ≥ c₄ where sₘₐₓ and sₘᵢₙ are the largest and smallest
  in set
  S₃ ∪ S₂′ \ {m₂ + k₂M}, when the SCS of PSFCH is 30 kHz;
    m₂ + k₂M is not included in set S₂, and m₂ + k₂M is removed from
    S₂′;
  Otherwise
    m₂ + k₂M is included in set S₂;
  End
End
```

5. The UE determines S₂ and S₃ as the RBs for PSFCH.

In yet another example, the UE procedure for determining the resources for the second type of PSFCH can be as follows:
1. The UE determines an index of the RB-set.
2. The UE determines an index of the second interlace and then decide a set S′₂={m₂, m₂+M, m₂+2M, . . . , m₂+k₂M, . . . , m₂+(K₂−1)M}, based on the index of the second interlace and the RB-set.
3. The UE determines an index of the third interlace and a number of RBs in the third interlace, and then decide the set S₃ according to one or more examples of this disclosure.

```
For k₂ = 0 to K₂ − 1
  If |m₂ + k₂M − s₃ − 1| ≤ 5 for any s₃ ∈ S₃ and if |sₘₐₓ − sₘᵢₙ + 1| ≥
  89 where
  sₘₐₓ and sₘᵢₙ are the largest and smallest in set S₃ ∪ S₂′ \ {m₂ + k₂M},
  when the
  SCS of PSFCH is 15 kHz; and/or if |m₂ + k₂M − s₃ − 1| ≤ 2 for any
  s₃ ∈ S₃ and
  if |sₘₐₓ − sₘᵢₙ + 1| ≥ 45 where sₘₐₓ and sₘᵢₙ are the largest and smallest
  in set
  S₃ ∪ S₂′ \ {m₂ + k₂M}, when the SCS of PSFCH is 30 kHz;
    m₂ + k₂M is not included in set S₂, and m₂ + k₂M is removed from
    S₂′;
  Otherwise
    m₂ + k₂M is included in set S₂;
  End
End
```

5. The UE determines S₂ and S₃ as the RBs for PSFCH.

In one example, there can be an explicit indication on whether the first type or the second type of PSFCH is utilized. For instance, the explicit indication can be included in a (pre-)configuration, e.g., the (pre-)configuration is associated with a resource pool. For another instance, the explicit indication can be included in a SCI.

In another example, there can be an explicit indication on which one of the following PSFCH is used: 1) the first type of PSFCH, 2) the second type of PSFCH, or 3) the common PSFCH occupying one RB. For instance, the explicit indication can be included in a (pre-)configuration, e.g., the (pre-)configuration is associated with a resource pool or a SL BWP. For another instance, the explicit indication can be included in a SCI.

In yet another example, there can be an explicit indication on which one of the following PSFCH is used: 1) the first type of PSFCH, or 2) the second type of PSFCH, and when the indication is not provided, the resource for PSFCH is occupying one RB. For instance, the explicit indication can be included in a (pre-)configuration, e.g., the (pre-)configuration is associated with a resource pool or a SL BWP. For another instance, the explicit indication can be included in a SCI.

In yet another example, there can be an explicit indication on which one of the following PSFCH is used: 1) the new PSFCH occupying more than one RB (e.g., the first or the second type of PSFCH), or 2) the common PSFCH occupying one RB. For instance, the explicit indication can be included in a (pre-)configuration, e.g., the (pre-)configuration is associated with a resource pool or a SL BWP. For another instance, the explicit indication can be included in a SCI.

In yet another example, if a UE is provided with information on an interlace (e.g., an index of the interlace), and not provided with information on RBs in another interlace (e.g., a number of RBs), the UE can determine the PSFCH is the second type of PSFCH; otherwise, the UE can determine the PSFCH is the first type of PSFCH.

In yet another example, if a UE is provided with information on an interlace (e.g., an index of the interlace) and/or information on RBs in another interlace (e.g., a number of RBs), the UE can determine the PSFCH is the second type of PSFCH; otherwise, the UE can determine the PSFCH is the first type of PSFCH.

In yet another example, the first type of PSFCH is the default type of PSFCH. The UE expects the PSFCH is the first type of PSFCH if no (pre-)configuration is provided.

In yet another example, the second type of PSFCH is the default type of PSFCH. The UE expects the PSFCH is the second type of PSFCH if no (pre-)configuration is provided.

In one example, the first type of PSFCH and/or the second type of PSFCH is applicable for a SCS of the PSFCH as 15 kHz and/or 30 kHz.

In one embodiment, for each RB in the set of RBs for resource allocation of PSFCH, e.g., the first type and the second type of PSFCH, a sequence of length 12 is generated and mapped to the REs in the RB. For instance, the sequence generated for each RB is a type 1 low peak-to-average power ratio (PAPR) sequence (e.g., ZC-sequence), e.g., the same way of sequence generation for physical uplink control channel (PUCCH) format 0 and/or 1 expect for the exemptions described in the disclosure.

In one example, m_{CS} for computing a value of cyclic shift α in sequence generation for PSFCH can be determined based on the HARQ-ACK feedback and/or conflict information, e.g., as in document and standard [3].

In another example, m0 for computing a value of cyclic shift α in sequence generation for PSFCH can be determined based on a cyclic shift pair index corresponding to a PSFCH resource index and a number of cyclic shift pairs (e.g., provided by a (pre-)configuration per resource pool), e.g., as in document and standard [3].

In yet another example, mᵢₙₜ for computing a value of cyclic shift α in sequence generation for PSFCH can be determined as mᵢₙₜ=cᵢₙₜ·i_{IRB}.
For one instance, cᵢₙₜ is a constant integer, e.g., cᵢₙₜ=5. Further, this instance can be applicable to RBs in S₁ for the first type of PSFCH, and/or RBs in S₂ for the second type of PSFCH. Further, this instance can be applicable to RBs in S₁ for the first type of PSFCH, and/or RBs in S₂ for the second type of PSFCH, and/or RBs in S₃ for the second type of PSFCH.
For another instance, cᵢₙₜ is an integer and determined based on the number of RBs in S₃. Further, this instance can be applicable to RBs in S₃ for the second type of PSFCH.
   For one sub-instance, when the number of RBs in the third interlace is 1, and S₃={k′₃}, cᵢₙₜ=50.
   For another sub-instance, when the number of RBs in the third interlace is 2, and S₃={k′₃, k′₃+5}, cᵢₙₜ=25.
   For yet another sub-instance, when the number of RBs in the third interlace is 2, and S₃={k′₃, k′₃+1}, cᵢₙₜ=5.
   For yet another sub-instance, when the number of RBs in the third interlace is 5, and S₃={k′₃, k′₃+2, k′₃+4, k′₃+6, k′₃+8}, cᵢₙₜ=10.
   For yet another sub-instance, when the number of RBs in the third interlace is 5, and S₃={k′₃, k′₃+1, k′₃+2, k′₃+3, k′₃+4}, cᵢₙₜ=5.
For yet another instance, i_{IRB} is index of the resource block number within the interlace and within the RB-set. Further, this instance can be applicable to RBs in S₁ for the first type of PSFCH, and/or RBs in S₂ for the second type of PSFCH. Further, this instance can be applicable to RBs in S₁ for the first type of PSFCH, and/or RBs in S₂ for the second type of PSFCH, and/or RBs in S₃ for the second type of PSFCH.
For yet another instance, i_{IRB} is index of the resource block number within the RBs in set S₁ and/or S₂ and/or S₃ (e.g., the RBs are ordered from lowest to highest).

In yet another example, l=0.

In yet another example, l′ is the index of the OFDM symbol in the slot that corresponds to the second OFDM symbol of the PSFCH transmission.

In yet another example, parameter u for the sequence generation can be determined as u=n_{ID} mod 30, wherein n_{ID} can be provided by a (pre-)configuration for RBs in S₂ in the second type of PSFCH; otherwise, u=0. For one instance, the (pre-)configuration can be a different one from the higher layer parameter for the ID of PSFCH hopping. For another instance, the (pre-)configuration can be the same as or associated with the (pre-) configuration for using type 1 and/or type 2 PSFCH.

In yet another example, parameter u for the sequence generation can be determined as u=(n_{ID}+n_{ID}′) mod 30, wherein n_{ID} can be provided by the higher layer parameter for the ID of PSFCH hopping (e.g., sl-PSFCH-HopID), and n_{ID}′ can be provided by a (pre-)configuration for RBs in S₂ in the second type of PSFCH; otherwise, u=0. For one instance, the (pre-)configuration can be a different one from the higher layer parameter for the ID of PSFCH hopping. For another instance, the (pre-)configuration can be the same as or associated with the (pre-)configuration for using type 1 and/or type 2 PSFCH.

In yet another example, parameter cᵢₙᵢₜ for the sequence generation can be determined as cᵢₙᵢₜ=n_{ID}, wherein n_{ID} can be provided by a (pre-)configuration, for RBs in S₂ in the second type of PSFCH; otherwise, cᵢₙᵢₜ=0. For one instance, the (pre-)configuration can be a different one from the higher layer parameter for the ID of PSFCH hopping. For another instance, the (pre-)configuration can be the same as or associated with the (pre-)configuration for using type 1 and/or type 2 PSFCH.

In yet another example, parameter cᵢₙᵢₜ for the sequence generation can be determined as cᵢₙᵢₜ=(n_{ID}+n_{ID}′) mod 2³¹, wherein n_{ID} can be provided by the higher layer parameter for the ID of PSFCH hopping (e.g., sl-PSFCH-HopID), and n_{ID}′ can be provided by a (pre-)configuration for RBs in S₂ in the second type of PSFCH; otherwise, cᵢₙᵢₜ=0. For one instance, the (pre-)configuration can be a different one from the higher layer parameter for the ID of PSFCH hopping. For another instance, the (pre-)configuration can be the same as or associated with the (pre-)configuration for using type 1 and/or type 2 PSFCH.

In one embodiment, a mapping between resources for PSSCH and resources for PSFCH can be predefined, for the first type and/or the second type of PSFCH.

In one example, the following procedure can be applicable for the first type of PSFCH.

A UE can be provided a set of RBs available for PSFCH in a resource pool from a (pre-)configuration (e.g., sl-PSFCH-RB-Set or sl-RB-SetPSFCH). The UE then determine M_{PRB, set}^{PSFCH} interlaces in the RB-set for PSFCH transmission that are available for PSFCH based on the (pre-)configuration, e.g., all RBs in the interlace within the interlaces and within the RB-set determined for PSFCH transmission are indicated as available according to the (pre-)configuration. Further, the determination of M_{PRB, set}^{PSFCH} can be separately performed for HARQ-ACK feedback (e.g., using sl-PSFCH-RB-Set) and conflict information (e.g., using sl-RB-SetPSFCH), assuming the RBs (e.g., RBs in interlaces) for HARQ-ACK feedback and conflict information are different. The (pre-)configuration (pre-)configuration (e.g., sl-PSFCH-RB-Set or sl-RB-SetPSFCH) can be provided per transmission occasion of the PSFCH. The procedure herein can be repeated for each transmission occasion of the PSFCH (e.g., for each transmission occasion, the procedure herein is performed separately using the corresponding parameters associated with the transmission occasion).

A UE can determine a number N_{subch} of sub-channels in the RB-set for the PSSCH transmission (or the lowest RB-set within the RB-sets for the PSSCH transmission, when the PSSCH transmission occupies multiple RB-sets), e.g., based on a (pre-)configuration (e.g., sl-NumSubchannel). For one instance, the (pre-)configuration can be common for all the RB-sets. For another instance, the (pre-)configuration can be separate for different RB-sets.

A UE can determine a number N_{PSSCH}^{PSFCH} based on a (pre-)configuration (e.g., sl-PSFCH-Period).
For instance, N_{PSSCH}^{PSFCH} can be same as the (pre-)configuration.
For another instance, N_{PSSCH}^{PSFCH}=N·N_{LBT}^{PSFCH}, wherein N is the (pre-)configuration, N_{LBT}^{PSFCH} is a number of PSFCH transmission occasions associated with one PSSCH transmission (e.g., to mitigate the impact from LBT), and the number can be provided by another (pre-)configuration.
For yet another instance, N_{PSSCH}^{PSFCH}=N/N_{LBT}^{PSFCH}, wherein N is the (pre-)configuration, N_{LBT}^{PSFCH} is a number of PSFCH transmission occasions associated with one PSSCH transmission (e.g., to mitigate the impact from LBT), and the number can be provided by another (pre-)configuration.
For yet another instance, N_{PSSCH}^{PSFCH}=N·N_{LBT}^{PSFCH}/N^{RB-set}, wherein N is the (pre-)configuration, N_{LBT}^{PSFCH} is a number of PSFCH transmission occasions associated with one PSSCH transmission (e.g., to mitigate the impact from LBT), the number can be provided by another (pre-)configuration, and N^{RB-set} is a number of RB-sets in the resource pool, or a number of RB-sets associated with the PSSCH, or a number of RB-sets selected for PSFCH transmission.
For yet another instance, N_{PSSCH}^{PSFCH}=N/(N_{LBT}^{PSFCH}·N^{RB-set}), wherein N is the (pre-)configuration, N_{LBT}^{PSFCH} is a number of PSFCH transmission occasions associated with one PSSCH transmission (e.g., to mitigate the impact from LBT), the number can be provided by another (pre-)configuration, and N^{RB-set} is a number of RB-sets in the resource pool, or a number of RB-sets associated with the PSSCH, or a number of RB-sets selected for PSFCH transmission.

A UE allocates the [(i+j·N_{PSSCH}^{PSFCH})·M_{subch, slot}^{PSFCH}, (i+1+j·N_{PSSCH}^{PSFCH})·M_{subch, slot}^{PSFCH}−1] interlaces from the M_{PRB, set}^{PSFCH} interlaces to slot i among the PSSCH slots associated with the PSFCH slot and sub-channel j, where M_{subch, slot}^{PSFCH}=M_{PRB, set}^{PSFCH}/(N_{subch}·N_{PSSCH}^{PSFCH}), 0≤i<N_{PSSCH}^{PSFCH}, 0≤j<N_{subch}. The allocation starts in an ascending order of i and continues in an ascending order of j. The UE expects that M_{PRB, set}^{PSFCH} is a multiple of N_{subch}·N_{PSSCH}^{PSFCH}.

In another example, the following procedure can be applicable for the first type of PSFCH.

A UE can be provided a set of RBs available for PSFCH in a resource pool from a (pre-)configuration (e.g., sl-PSFCH-RB-Set or sl-RB-SetPSFCH). The UE (e.g., the UE 111) then determine M_{PRB, set}^{PSFCH} interlaces in the RB-set for PSFCH transmission that are available for PSFCH based on the (pre-)configuration, e.g., all RBs in the interlace within the interlaces and within a RB-set within the resource pool are indicated as available according to the (pre-)configuration. Further, the determination of M_{PRB, set}^{PSFCH} can be separately performed for HARQ-ACK feedback and conflict information, assuming the RBs for HARQ-ACK feedback and conflict information are different. The (pre-)configuration (pre-)configuration (e.g., sl-PSFCH-RB-Set or sl-RB-SetPSFCH) can be provided per transmission occasion of the PSFCH. The procedure herein can be repeated for each transmission occasion of the PSFCH (e.g., for each transmission occasion, the procedure herein is performed separately using the corresponding parameters associated with the transmission occasion).

A UE can determine a number N_{subch} of sub-channels in the resource pool, e.g., based on a (pre-)configuration (e.g., sl-NumSubchannel).

A UE can determine a number N_{PSSCH}^{PSFCH} based on a (pre-)configuration (e.g., sl-PSFCH-Period).
For instance, N_{PSSCH}^{PSFCH} can be same as the (pre-)configuration.
For another instance, N_{PSSCH}^{PSFCH}=N·N_{LBT}^{PSFCH}, wherein N is the (pre-)configuration, N_{LBT}^{PSFCH} is a number of PSFCH transmission occasions associated with one PSSCH transmission (e.g., to mitigate the impact from LBT), and the number can be provided by another (pre-)configuration.
For yet another instance, N_{PSSCH}^{PSFCH}=N/N_{LBT}^{PSFCH}, wherein N is the (pre-)configuration, N_{LBT}^{PSFCH} is a number of PSFCH transmission occasions associated with one PSSCH transmission (e.g., to mitigate the impact from LBT), and the number can be provided by another (pre-)configuration.
For yet another instance, N_{PSSCH}^{PSFCH}=N·N_{LBT}^{PSFCH}/N^{RB-set}, wherein N is the (pre-)configuration, N_{LBT}^{PSFCH} is a number of PSFCH transmission occasions associated with one PSSCH transmission (e.g., to mitigate the impact from LBT), the number can be provided by another (pre-)configuration, and N^{RB-set} is a number of RB-sets in the resource pool, or a number of RB-sets associated with the PSSCH, or a number of RB-sets selected for PSFCH transmission.
For yet another instance, N_{PSSCH}^{PSFCH}=N/(N_{LBT}^{PSFCH}·N^{RB-set}), wherein N is the (pre-)configuration, N_{LBT}^{PSFCH} is a number of PSFCH transmission occasions associated with one PSSCH transmission (e.g., to mitigate the impact from LBT), the number can be provided by another (pre-)configuration, and N^{RB-set} is a number of RB-sets in the resource pool, or a number of RB-sets associated with the PSSCH, or a number of RB-sets selected for PSFCH transmission.

A UE allocates the [(i+j·N_{PSSCH}^{PSFCH})·M_{subch, slot}^{PSFCH}, (i+1+j·N_{PSSCH}^{PSFCH})·M_{subch, slot}^{PSFCH}−1] interlaces from the M_{PRB, set}^{PSFCH} interlaces to slot i among the PSSCH slots associated with the PSFCH slot and sub-channel j, where M_{subch, slot}^{PSFCH}=M_{PRB, set}^{PSFCH}/(N_{subch}·N_{PSSCH}^{PSFCH}), 0≤i<N_{PSSCH}^{PSFCH}, 0≤j<N_{subch}, and the allocation starts in an ascending order of i and continues in an ascending order of j. The UE expects that M_{PRB, set}^{PSFCH} is a multiple of N_{subch}·N_{PSSCH}^{PSFCH}.

In another example, the following procedure can be applicable for the first type of PSFCH.

A UE can determine an interlace index for the second interlace in the second type of PSFCH, e.g., according to an example in the disclosure.

A UE can be provided a set of RBs available for PSFCH in a resource pool from a (pre-)configuration (e.g., sl-PSFCH-RB-Set or sl-RB-SetPSFCH). For one instance, the UE expects the RBs corresponding to the second interlace in the second type of PSFCH are not indicated as available in the (pre-)configuration. For another instance, the UE excludes the RBs corresponding to the second interlace in the second type of PSFCH from the (pre-)configuration and perform the successive procedures.

The UE then determines M_{PRB, set}^{PSFCH} groups of RBs in the RB-set for PSFCH transmission that are available for PSFCH based on the (pre-)configuration, wherein the group of RBs are following example of S₃ as described in the disclosure. Further, the determination of M_{PRB, set}^{PSFCH} can be separately performed for HARQ-ACK feedback (e.g., using sl-PSFCH-RB-Set) and conflict information (e.g., using sl-RB-SetPSFCH), assuming the RBs (e.g., RBs in the group of RBs) for HARQ-ACK feedback and conflict information are different. Further, the number of groups of RBs in an interlace and within one RB-set can be expected to be determined according to M_{PRB,k,l}^{PSFCH,n}/N_{PRB}^{PSFCH} (e.g., expected to be an integer), wherein M_{PRB,k,l}^{PSFCH,n} is the number of RBs in the interlace and RB-set, and N_{PRB}^{PSFCH} is the number of RBs in the group of RBs, e.g., e.g., the number of groups is 10 or 11 when the number of RB is 1; and/or the number of groups is 5 when the number of RB is 2; and/or the number of groups is 2 when the number of RB is 5. Further, the groups of RBs in the RB-set can be indexed first within an interlace and RB-set, then across interlaces in a RB-set, e.g., all in a lowest to highest order in the frequency domain. Further, the groups of RBs in the resource pool can be indexed first within an interlace and RB-set in an order of lowest to highest frequency, then across interlaces in a RB-set in an order of interlaces.

The (pre-)configuration (pre-)configuration (e.g., sl-PSFCH-RB-Set or sl-RB-SetPSFCH) can be provided per transmission occasion of the PSFCH. The procedure herein can be repeated for each transmission occasion of the PSFCH (e.g., for each transmission occasion, the procedure herein is performed separately using the corresponding parameters associated with the transmission occasion).

A UE can determine a number N_{subch} of sub-channels in the RB-set for the PSSCH transmission (or the lowest RB-set within the RB-sets for the PSSCH transmission, when the PSSCH transmission occupies multiple RB-sets), e.g., based on a (pre-)configuration (e.g., sl-NumSubchannel). For one instance, the (pre-)configuration can be common for all the RB-sets. For another instance, the (pre-)configuration can be separate for different RB-sets.

A UE can determine a number N_{PSSCH}^{PSFCH} based on a (pre-)configuration (e.g., sl-PSFCH-Period).
For instance, N_{PSSCH}^{PSFCH} can be same as the (pre-)configuration.
For another instance, N_{PSSCH}^{PSFCH}=N·N_{LBT}^{PSFCH}, wherein N is the (pre-)configuration, N_{LBT}^{PSFCH} is a number of PSFCH transmission occasions associated with one PSSCH transmission (e.g., to mitigate the impact from LBT), and the number can be provided by another (pre-)configuration.
For yet another instance, N_{PSSCH}^{PSFCH}=N/N_{LBT}^{PSFCH}, wherein N is the (pre-)configuration, N_{LBT}^{PSFCH} is a number of PSFCH transmission occasions associated with one PSSCH transmission (e.g., to mitigate the impact from LBT), and the number can be provided by another (pre-)configuration.
For yet another instance, N_{PSSCH}^{PSFCH}=N·N_{LBT}^{PSFCH}/N^{RB-set}, wherein N is the (pre-)configuration, N_{LBT}^{PSFCH} is a number of PSFCH transmission occasions associated with one PSSCH transmission (e.g., to mitigate the impact from LBT), the number can be provided by another (pre-)configuration, and N^{RB-set} is a number of RB-sets in the resource pool, or a number of RB-sets associated with the PSSCH, or a number of RB-sets selected for PSFCH transmission.
For yet another instance, N_{PSSCH}^{PSFCH}=N/(N_{LBT}^{PSFCH}·N^{RB-set}), wherein N is the (pre-)configuration, N_{LBT}^{PSFCH} is a number of PSFCH transmission occasions associated with one PSSCH transmission (e.g., to mitigate the impact from LBT), the number can be provided by another (pre-)configuration, and N^{RB-set} is a number of RB-sets in the resource pool, or a number of RB-sets associated with the PSSCH, or a number of RB-sets selected for PSFCH transmission.

A UE allocates the [(i+j·N_{PSSCH}^{PSFCH})·M_{subch, slot}^{PSFCH}, (i+1+j·N_{PSSCH}^{PSFCH})·M_{subch, slot}^{PSFCH}−1] groups of RBs from the M_{PRB, set}^{PSFCH} group of RBs to slot i among the PSSCH slots associated with the PSFCH slot and sub-channel j, where M_{subch, slot}^{PSFCH}=M_{PRB, set}^{PSFCH}/(N_{subch}·N_{PSSCH}^{PSFCH}), 0≤i<N_{PSSCH}^{PSFCH}, 0≤j<N_{subch}. The allocation starts in an ascending order of i and continues in an ascending order of j. The UE expects that M_{PRB, set}^{PSFCH} is a multiple of N_{subch}·N_{PSSCH}^{PSFCH}.

Further, the example is applicable for conflict information when sl-PSFCH-Occasion=‘1’.

Further, the example is applicable for conflict information when sl-PSFCH-Occasion=‘0’.

In another example, the following procedure can be applicable for the second type of PSFCH.

A UE can determine an interlace index for the second interlace in the second type of PSFCH, e.g., according to an example in the disclosure.

A UE can be provided a set of RBs available for PSFCH in a resource pool from a (pre-)configuration (e.g., sl-PSFCH-RB-Set or sl-RB-SetPSFCH). For one instance, the UE expects the RBs corresponding to the second interlace in the second type of PSFCH are not indicated as available in the (pre-)configuration. For another instance, the UE excludes the RBs corresponding to the second interlace in the second type of PSFCH from the (pre-)configuration and perform the successive procedures.

The (pre-)configuration (pre-)configuration (e.g., sl-PSFCH-RB-Set or sl-RB-SetPSFCH) can be provided per transmission occasion of the PSFCH. The procedure herein can be repeated for each transmission occasion of the PSFCH (e.g., for each transmission occasion, the procedure herein is performed separately using the corresponding parameters associated with the transmission occasion).

The UE then determines M_{PRB, set}^{PSFCH} groups of RBs in the resource pool based on the (pre-)configuration, wherein the group of RBs are following example of S₃ as described in the disclosure. Further, the determination of M_{PRB, set}^{PSFCH} can be separately performed for HARQ-ACK feedback and conflict information, assuming the RBs for HARQ-ACK feedback and conflict information are different. Further, the number of groups of RBs in an interlace and within one RB-set can be expected to be determined based on a number of RBs in the group of RBs, e.g., the number of groups is 10 or 11 when the number of RB is 1; and/or the number of groups is 5 when the number of RB is 2; and/or the number of groups is 2 when the number of RB is 5. Further, the groups of RBs in the resource pool can be indexed first within an interlace and RB-set, then across interlaces in a RB-set, then across RB-sets, e.g., all in a lowest to highest order in the frequency domain. Further, the groups of RBs in the resource pool can be indexed first within an interlace and RB-set in an order of lowest to highest frequency, then across interlaces in a RB-set in an order of interlaces, then across RB-sets in an order of RB-set indexes.

A UE can determine a number N_{subch} of sub-channels in the resource pool (or the lowest RB-set within the RB-sets for the PSSCH transmission, when the PSSCH transmission occupies multiple RB-sets), e.g., based on a (pre-)configuration (e.g., sl-NumSubchannel).

A UE can determine a number N_{PSSCH}^{PSFCH} based on a (pre-)configuration (e.g., sl-PSFCH-Period).
For instance, N_{PSSCH}^{PSFCH} can be same as the (pre-)configuration.
For another instance, N_{PSSCH}^{PSFCH}=N·N_{LBT}^{PSFCH}, wherein N is the (pre-)configuration, N_{LBT}^{PSFCH} is a number of PSFCH transmission occasions associated with one PSSCH transmission (e.g., to mitigate the impact from LBT), and the number can be provided by another (pre-)configuration.
For yet another instance, N_{PSSCH}^{PSFCH}=N/N_{LBT}^{PSFCH}, wherein N is the (pre-)configuration, N_{LBT}^{PSFCH} is a number of PSFCH transmission occasions associated with one PSSCH transmission (e.g., to mitigate the impact from LBT), and the number can be provided by another (pre-)configuration.
For yet another instance, N_{PSSCH}^{PSFCH}=N·N_{LBT}^{PSFCH}/N^{RB-set}, wherein N is the (pre-)configuration, N_{LBT}^{PSFCH} is a number of PSFCH transmission occasions associated with one PSSCH transmission (e.g., to mitigate the impact from LBT), the number can be provided by another (pre-)configuration, and N^{RB-set} is a number of RB-sets in the resource pool, or a number of RB-sets associated with the PSSCH, or a number of RB-sets selected for PSFCH transmission. For yet another instance, N_{PSSCH}^{PSFCH}=N/(N_{LBT}^{PSFCH}·N^{RB-set}), wherein N is the (pre-)configuration, N_{LBT}^{PSFCH} is a number of PSFCH transmission occasions associated with one PSSCH transmission (e.g., to mitigate the impact from LBT), the number can be provided by another (pre-)configuration, and N^{RB-set} is a number of RB-sets in the resource pool, or a number of RB-sets associated with the PSSCH, or a number of RB-sets selected for PSFCH transmission.

A UE allocates the [(i+j·N_{PSSCH}^{PSFCH})·M_{subch, slot}^{PSFCH}, (i+1+j·N_{PSSCH}^{PSFCH})·M_{subch, slot}^{PSFCH}−1] groups of RBs from the M_{PRB, set}^{PSFCH} group of RBs to slot i among the PSSCH slots associated with the PSFCH slot and sub-channel j, where M_{subch, slot}^{PSFCH}=M_{PRB, set}^{PSFCH}/(N_{subch}·N_{PSSCH}^{PSFCH}), 0≤i<N_{PSSCH}^{PSFCH}, 0≤j<N_{subch}. The allocation starts in an ascending order of i and continues in an ascending order of j. The UE expects that M_{PRB, set}^{PSFCH} is a multiple of N_{subch}·N_{PSSCH}^{PSFCH}.

Further, the example is applicable for conflict information when sl-PSFCH-Occasion=‘1’.

Further, the example is applicable for conflict information when sl-PSFCH-Occasion=‘0’.

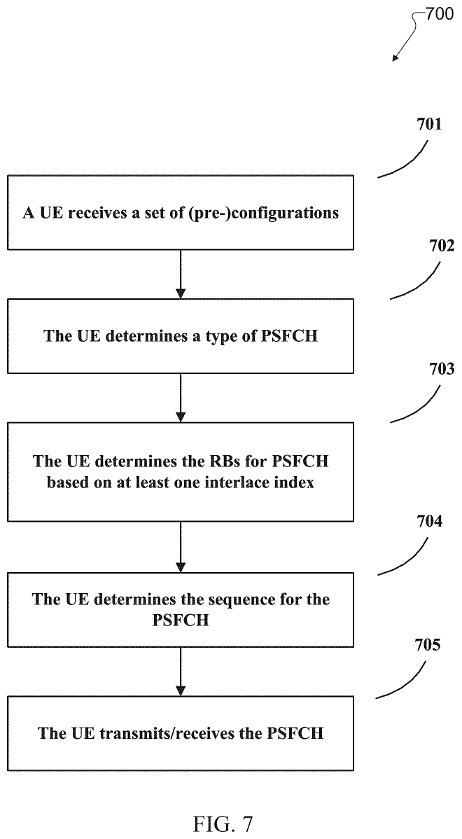

FIG. 7 illustrates a flowchart of an example UE procedure 700 for PSFCH transmission/reception according to embodiments of the present disclosure. For example, procedure 700 for PSFCH transmission/reception can be performed by any of the UEs 111-111C, such as the UE 111C. This example is for illustration only and other embodiments can be used without departing from the scope of the present disclosure.

The procedure begins in 701, a UE receives a set of (pre-)configurations. In 702, the UE determines a type of PSFCH. In 703, the UE determines the RBs for PSFCH based on at least one interlace index. In 704, the UE determines the sequence for the PSFCH. In 705, the UE transmits/receives the PSFCH.

For example, in 701, the UE may receive higher layer parameters, and in 702, determine the type based on determining whether a first higher layer parameter is included in the higher layer parameters and determining, based on the first higher layer parameter from the higher layer parameters, the PSFCH transmission type when the first higher layer parameter is included in the higher layer parameters. For example, in 704, the UE may determine RBs in the RB set used for the transmission of the PSFCH based on the PSFCH transmission type, where all RBs in a first interlace are used for the transmission of the PSFCH when the PSFCH transmission type is a first type, or RBs in a second interlace and RBs in a third interlace are used for the transmission of the PSFCH when the PSFCH transmission type is a second type. For example, in 705, the UE may transmit the PSFCH according to the RBs in the RB set.

In one embodiment, a UE can attempt to perform a PSFCH transmission on a number N_{occasion}^{PSFCH} of candidate transmission occasions, where N_{occasion}^{PSFCH} is provided by a (pre-)configuration.

For one example, for operation with shared spectrum channel access, the UE (e.g., the UE 111) can attempt to transmit the PSFCH over a number of first N_{occasion}^{PSFCH} slots provided by a (pre-)configuration (e.g., sl-candidatePSFCH-Occasions) that include PSFCH resources and are at least a number of slots, provided by a (pre-)configuration (e.g., sl-MinTimeGapPSFCH), of the resource pool after a last slot of the PSSCH reception. The UE attempts to transmit in a slot only when the UE fails to transmit in all previous slots.

For another example, for operation with shared spectrum channel access, the UE transmits a PSFCH with conflict information corresponding to a reserved resource indicated in an SCI format 1-A. The UE transmits the PSFCH in the resource pool in a slot determined based on sl-PSFCH-Occasion.

For one sub-example, if sl-PSFCH-Occasion=‘0’, the UE can attempt to transmit the PSFCH over a number of first N_{occasion}^{PSFCH} slots provided by a (pre-)configuration (e.g., sl-candidatePSFCH-Occasions) that include PSFCH resources and are at least a number of slots, provided by a (pre-)configuration (e.g., sl-MinTimeGapPSFCH), of the resource pool after a last slot of a physical sidelink control channel (PSCCH) reception that provides the SCI format 1-A. If the PSFCH resource is in a slot within the N_{occasion}^{PSFCH} slots that is at least T₃ slots before the resource associated with the conflict information, the UE can attempt to transmit the PSFCH with conflict information in such slot; otherwise, the UE does not transmit the PSFCH with conflict information in such slot. The UE attempts to transmit in a slot only when all the previous slots are the ones the UE fails to transmit or does not transmit in.

For another sub-example, if sl-PSFCH-Occasion=‘0’, the UE can attempt to transmit the PSFCH over a number of first N_{occasion}^{PSFCH} slots provided by a (pre-)configuration (e.g., sl-candidatePSFCH-Occasions) that include PSFCH resources and are at least a number of slots, provided by a (pre-)configuration (e.g., sl-MinTimeGapPSFCH), of the resource pool after a last slot of a PSCCH reception that provides the SCI format 1-A. If all the N_{occasion}^{PSFCH} slots are at least T₃ slots before the resource associated with the conflict information, the UE can attempt to transmit the PSFCH with conflict information in those slots; otherwise, the UE does not transmit the PSFCH with conflict information in those slots. The UE attempts to transmit in a slot only when all the previous slots are the ones the UE fails to transmit or does not transmit in.

For yet another sub-example, if sl-PSFCH-Occasion=‘1’, the UE can attempt to transmit the PSFCH over a number of latest N_{occasion}^{PSFCH} slots provided by a (pre-)configuration (e.g., sl-candidatePSFCH-Occasions) that include PSFCH resources and are at least T₃ slots of the resource pool before a slot of the resource associated with conflict information. If the PSFCH/PSFCH resource in a slot within the N_{occasion}^{PSFCH} slots is that is at least sl-MinTimeGapPSFCH slots after a slot of a PSCCH reception that provides the SCI format 1-A, the UE can attempt to transmit the PSFCH with conflict information in such slot; otherwise, the UE does not transmit the PSFCH with conflict information in such slot. The UE attempts to transmit in a slot only when all the previous slots are the ones the UE fails to transmit or does not transmit in.

For yet another sub-example, if sl-PSFCH-Occasion=‘1’, the UE can attempt to transmit the PSFCH over a number of latest N_{occasion}^{PSFCH} slots provided by a (pre-)configuration (e.g., sl-candidatePSFCH-Occasions) that include PSFCH resources and are at least T₃ slots of the resource pool before a slot of the resource associated with conflict information. If all the N_{occasion}^{PSFCH} slots are at least sl-MinTimeGapPSFCH slots after a slot of a PSCCH reception that provides the SCI format 1-A, the UE can attempt to transmit the PSFCH with conflict information in those slots; otherwise, the UE does not transmit the PSFCH with conflict information in the N_{occasion}^{PSFCH} slots. The UE attempts to transmit in a slot only when all the previous slots are the ones the UE fails to transmit or does not transmit in.

In one embodiment, for conflict information, the application of the second type of PSFCH is for sl-PSFCH-Occasion=‘0’.

For one example, if a UE is provided with a (pre-)configuration indicating the second type of PSFCH, and sl-PSFCH-Occasion=‘0’, the UE applies the second type of PSFCH for a PSFCH transmission with conflict information; if the UE is provided with the (pre-)configuration indicating the second type of PSFCH, and sl-PSFCH-Occasion=‘1’, the UE applies the common PSFCH occupying one PRB for a PSFCH transmission with conflict information.

For another example, if a UE is provided with a (pre-)configuration indicating the second type of PSFCH, the UE applies the second type of PSFCH for a PSFCH transmission with HARQ-ACK information.

For one example, if a UE is provided with a (pre-)configuration indicating the second type of PSFCH, and if sl-PSFCH-Occasion=‘0’, the UE determines a first group of RBs in the third interlace of the second type of PSFCH for HARQ-ACK information and determines a second group of RBs in the third interlace of the second type of PSFCH for conflict information, wherein the first group of RBs and second group of RBs do not overlap.

For another example, if a UE is provided with a (pre-)configuration indicating the second type of PSFCH, and if sl-PSFCH-Occasion=‘1’, the UE determines a group of RBs in the third interlace of the second type of PSFCH for HARQ-ACK information determines the second interlace of the second type of PSFCH for HARQ-ACK information, and then determines one PRB for PSFCH transmission for conflict information (e.g., common PSFCH occupying one PRB), wherein the one PRB for conflict information does not belong to the group of RBs in the third interlace or the second interlace.

For yet another example, if a UE is provided with a (pre-)configuration indicating the second type of PSFCH, and if sl-PSFCH-Occasion=‘1’, the UE determines a group of RBs in the third interlace of the second type of PSFCH for HARQ-ACK information, determines the second interlace of the second type of PSFCH for HARQ-ACK information, may perform truncation to the PRBs in the second interlace to determine a set S₃ for PSFCH transmission, and then determines one PRB for PSFCH transmission for conflict information (e.g., common PSFCH occupying one PRB), wherein the one PRB for conflict information does not belong to S₃.

For yet another example, if a UE is provided with a (pre-)configuration indicating the second type of PSFCH, and if sl-PSFCH-Occasion=‘1’, the UE determines a group of RBs in the third interlace of the second type of PSFCH for HARQ-ACK information, determines the second interlace of the second type of PSFCH for HARQ-ACK information, and then determines one PRB for PSFCH transmission for conflict information (e.g., common PSFCH occupying one PRB), wherein the one PRB for conflict information does not belong to the group of RBs in the third interlace.

The above flowchart illustrates an example method that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive higher layer parameters; and
a processor operably coupled to the transceiver, the processor configured to:
determine whether a first higher layer parameter is included in the higher layer parameters;
determine, based on the first higher layer parameter from the higher layer parameters, a physical sidelink feedback channel (PSFCH) transmission type when the first higher layer parameter is included in the higher layer parameters;
determine a resource block (RB) set for a transmission of a PSFCH; and
determine RBs in the RB set used for the transmission of the PSFCH based on the PSFCH transmission type, wherein:
all RBs in a first interlace are used for the transmission of the PSFCH when the PSFCH transmission type is a first type, or
RBs in a second interlace and RBs in a third interlace are used for the transmission of the PSFCH when the PSFCH transmission type is a second type, and
wherein the transceiver is further configured to transmit the PSFCH according to the RBs in the RB set.

2. The UE of claim 1, wherein the processor is further configured to determine a RB in the RB set to use for the transmission of the PSFCH when the first higher layer parameter is not included in the higher layer parameters.

3. The UE of claim 1, wherein, when the PSFCH transmission type is the first type, the processor is further configured to:
determine a transmission occasion for the transmission of the PSFCH;
determine that the transmission of the PSFCH is for hybrid automatic repeat request acknowledgement (HARQ-ACK) information;
determine, based on a second higher layer parameter from the higher layer parameters, a first set of interlaces, wherein:
the second higher layer parameter is associated with the transmission occasion for the transmission of the PSFCH, and
all RBs in the first set of interlaces are indicated as available; and
determine the first interlace, from the first set of interlaces, for the transmission of the PSFCH for the HARQ-ACK information.

4. The UE of claim 1, wherein, when the PSFCH transmission type is the first type, the processor is further configured to:
determine a transmission occasion for the transmission of the PSFCH;
determine that the transmission of the PSFCH is for conflict information;
determine, based on a second higher layer parameter from the higher layer parameters, a first set of interlaces, wherein:
the second higher layer parameter is associated with the transmission occasion for the transmission of the PSFCH,
all RBs in the first set of interlaces are indicated as available, and
different interlaces are determined for the first set of interlaces and a second set of interlaces for hybrid automatic repeat request acknowledgement (HARQ-ACK) information; and
determine the first interlace, from the first set of interlaces, for the transmission of the PSFCH for the conflict information.

5. The UE of claim 1, wherein, when the PSFCH transmission type is the second type, the processor is further configured to determine, based on a second higher layer parameter, an index for the second interlace.

6. The UE of claim 5, wherein the processor is further configured to:
determine a transmission occasion for the transmission of the PSFCH;
determine that the transmission of the PSFCH is for hybrid automatic repeat request acknowledgement (HARQ-ACK) information;
determine, based on a third higher layer parameter from the higher layer parameters, a first set of RB groups, wherein:
the third higher layer parameter is associated with the transmission occasion for the transmission of the PSFCH,
all RBs in the first set of RB groups are indicated as available, and
RBs in each RB group in the first set of RB groups are consecutive RBs in an interlace; and
determine a RB group from the first set of RB groups, wherein the RB group includes RBs in the third interlace for the transmission of the PSFCH for HARQ-ACK information.

7. The UE of claim 5, wherein the processor is further configured to:
determine a transmission occasion for the transmission of the PSFCH;
determine that the transmission of the PSFCH is for conflict information;
determine, based on a third higher layer parameter from the higher layer parameters, a first set of RB groups, wherein:
the third higher layer parameter is associated with the transmission occasion for the transmission of the PSFCH,
all RBs in the first set of RB groups are indicated as available,
RBs in a RB group in the first set of RB groups are consecutive RBs in an interlace, and
different RBs are determined for the first set of RB groups and a second set of RB groups for hybrid automatic repeat request acknowledgement (HARQ-ACK) information; and
determine a RB group from the first set of RB groups, wherein the RB group includes RBs in the third interlace for the transmission of the PSFCH for conflict information.

8. The UE of claim 7, wherein the processor is further configured to:
determine that a RB s₂ in the second interlace is not used for the transmission of the PSFCH, when a subcarrier spacing of the transmission of the PSFCH is 15 kilohertz (kHz), when:
1) |s₂−s₃|≤5 for any RB s₃ in the determined RB group in the third interlace, and
2) |s_max−s_min|≥88, wherein RB sₘₐₓ is a highest RB in RBs for the transmission of the PSFCH other than RB s₂ and wherein RB sₘᵢₙ is a lowest RB in RBs for the transmission of the PSFCH other than RB s₂.

9. The UE of claim 7, wherein the processor is further configured to:
determine a RB s₂ in the second interlace is not used for the transmission of the PSFCH, when a subcarrier spacing of the transmission of the PSFCH is 30 kilohertz (kHz), when:
1) |s₂−s₃|≤2 for any RB s₃ in the determined RB group in the third interlace, and
2) |s_max−s_min|≥44, wherein RB sₘₐₓ is a highest RB in RBs for the transmission of the PSFCH other than RB s₂ and wherein RB sₘᵢₙ is a lowest RB in RBs for the transmission of the PSFCH transmission other than RB s₂.

10. The UE of claim 1, wherein:
the processor is further configured to determine, based on a second higher layer parameter from the higher layer parameters, a set of configurations for a resource pool, and
the first higher layer parameter is associated with the set of configurations for the resource pool.

11. A method of a user equipment (UE) in a wireless communication system, the method comprising:
receiving higher layer parameters;
determining whether a first higher layer parameter is included in the higher layer parameters;
determining, based on the first higher layer parameter from the higher layer parameters, a physical sidelink feedback channel (PSFCH) transmission type when the first higher layer parameter is included in the higher layer parameters;
determining a resource block (RB) set for a transmission of a PSFCH;
determining RBs in the RB set used for the transmission of the PSFCH based on the PSFCH transmission type, wherein:
all RBs in a first interlace are used for the transmission of the PSFCH when the PSFCH transmission type is a first type; or
RBs in a second interlace and RBs in a third interlace are used for the transmission of the PSFCH when the PSFCH transmission type is a second type; and
transmitting the PSFCH according to the RBs in the RB set.

12. The method of claim 11 further comprising:
determining a RB in the RB set to use for the transmission of the PSFCH when the first higher layer parameter is not included in the higher layer parameters.

13. The method of claim 11 further comprising, when the PSFCH transmission type is the first type:
determining a transmission occasion for the transmission of the PSFCH;
determining that the transmission of the PSFCH is for hybrid automatic repeat request acknowledgement (HARQ-ACK) information;
determining, based on a second higher layer parameter from the higher layer parameters, a first set of interlaces, wherein:
the second higher layer parameter is associated with the transmission occasion for the transmission of the PSFCH, and
all RBs in the first set of interlaces are indicated as available; and
determining the first interlace, from the first set of interlaces, for the transmission of the PSFCH for the HARQ-ACK information.

14. The method of claim 11 further comprising, when the PSFCH transmission type is the first type:
determining a transmission occasion for the transmission of the PSFCH;
determining that the transmission of the PSFCH is for conflict information;
determining, based on a second higher layer parameter from the higher layer parameters, a first set of interlaces, wherein:
the second higher layer parameter is associated with the transmission occasion for the transmission of the PSFCH,
all RBs in the first set of interlaces are indicated as available, and
different interlaces are determined for the first set of interlaces and a second set of interlaces for hybrid automatic repeat request acknowledgement (HARQ-ACK) information; and
determining the first interlace, from the first set of interlaces, for the transmission of the PSFCH for the conflict information.

15. The method of claim 11 further comprising:
when the PSFCH transmission type is the second type, determining, based on a second higher layer parameter, an index for the second interlace.

16. The method of claim 15 further comprising:
determining a transmission occasion for the transmission of the PSFCH;
determining that the transmission of the PSFCH is for hybrid automatic repeat request acknowledgement (HARQ-ACK) information;
determining, based on a third higher layer parameter from the higher layer parameters, a first set of RB groups, wherein:
the third higher layer parameter is associated with the transmission occasion for the transmission of the PSFCH,
all RBs in the first set of RB groups are indicated as available, and
RBs in each RB group in the first set of RB groups are consecutive RBs in an interlace; and
determining a RB group from the first set of RB groups wherein the RB group includes RBs in the third interlace for the transmission of the PSFCH for HARQ-ACK information.

17. The method of claim 15 further comprising:
determining a transmission occasion for the transmission of the PSFCH;
determining that the transmission of the PSFCH is for conflict information;
determining, based on a third higher layer parameter from the higher layer parameters, a first set of RB groups, wherein:
the third higher layer parameter is associated with the transmission occasion for the transmission of the PSFCH,
all RBs in the first set of RB groups are indicated as available,
RBs in a RB group in the first set of RB groups are consecutive RBs in an interlace, and
different RBs are determined for the first set of RB groups and a second set of RB groups for hybrid automatic repeat request acknowledgement (HARQ-ACK) information; and
determining a RB group from the first set of RB groups, wherein the RB group includes RBs in the third interlace for the transmission of the PSFCH for conflict information.

18. The method of claim 17 further comprising:
determining that a RB s₂ in the second interlace is not used for the transmission of the PSFCH, when a subcarrier spacing of the transmission of the PSFCH is 15 kilohertz (kHz), when:
1) |s₂−s₃|≤5 for any RB s₃ in the determined RB group in the third interlace; and
2) |s_max−s_min|≥88, wherein RB sₘₐₓ is a highest RB in RBs for the transmission of the PSFCH other than RB s₂ and wherein RB sₘᵢₙ is a lowest RB in RBs for the transmission of the PSFCH other than RB s₂.

19. The method of claim 17 further comprising:
determining a RB s₂ in the second interlace is not used for the transmission of the PSFCH, when a subcarrier spacing of the transmission of the PSFCH is 30 kilohertz (kHz), when:
1) |s₂−s₃|≤2 for any RB s₃ in the determined RB group in the third interlace; and
2) |s_max−s_min|>44, wherein RB sₘₐₓ is a highest RB in RBs for the transmission of the PSFCH other than RB s₂ and wherein RB sₘᵢₙ is a lowest RB in RBs for the transmission of the PSFCH transmission other than RB s₂.

20. The method of claim 11 further comprising:
determining, based on a second higher layer parameter from the higher layer parameters, a set of configurations for a resource pool,
wherein the first higher layer parameter is associated with the set of configurations for the resource pool.
